(19) United States
(12) Patent Application Publication
(10) Pub. No.: US 2006/0230352 A1
(43) Pub. Date: Oct. 12, 2006

(54) Contextual error messaging

(75) Inventor: Robert E. Nielsen, Snoqualmie, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Ramp Technology Group, Bellevue, WA (US)

(21) Appl. No.: 11/370,260

(22) Filed: Mar. 7, 2006

Related U.S. Application Data
(60) Provisional application No. 60/659,655, filed on Mar. 7, 2005.

(51) Int. Cl. G06F 17/00; G06F 3/00; G06F 9/00

(52) U.S. Cl. 715/700; 715/780; 715/764

(57) ABSTRACT

A computer system and method for collecting and processing user input in data fields is presented. A set of data fields is organized according to one or more contextual groupings and displayed to a user in a user interface display. As user input is received for the set of data fields, a validation component validates the inputted data. If any errors or inconsistencies are detected, a subset of the data fields corresponding to a contextual grouping of the erroneous data field(s) is presented in subsequent user interface display.

This application claims the benefit of U.S. Provisional Application No. 60/659,655, entitled CONTEXTUAL ERROR MESSAGING, and filed on Mar. 7, 2005. U.S. Provisional Application No. 60/659,655 is incorporated by reference herein.

### BACKGROUND

As most people readily recognize, with the increased popularity of the Internet, the collection of user information via a computer system and a communication network has increased. For example, Web sites are commonly utilized to allow users to make purchases or submit information for processing. In a typical embodiment, a user can be presented with one or more user interface displays, such as Web pages, that include a number of data fields that need to be completed. In many situations, one or more of the data fields can designated as critical or required fields. Accordingly, a user may not be able to advance the data collection process unless each of the critical or required fields is completed properly.

To facilitate user information collection, current data collection systems can utilize a data validation process that processes user input from a data field. In the event that one or more user data inputs cannot be validated, the data collection system can identify the error fields on the user interface display. Additionally, the data collection system can provide additional details regarding the errors, including making suggestions to the user as to the proper form for the required/critical input. Although the data validation processes can facilitate user input collection, current approaches can become deficient in the identification of the error fields to users. In one aspect, in user interface displays including a large number of data fields, identification of the error fields may be problematic. In another aspect, users can become frustrated in continuously being displayed the same user interface display during the error correction process. Accordingly, users may abandon the data collection process and its associated transactions.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A computer system and method for collecting and processing user input in data fields is presented. A set of data fields is organized according to one or more contextual groupings and displayed to a user in a user interface display. As user input is received for the set of data fields, a validation component validates the inputted data. If any errors or inconsistencies are detected, a subset of the data fields corresponding to a contextual grouping of the erroneous data field(s) is presented in subsequent user interface display.

In accordance with an aspect of the present invention, a method for processing information from data fields is provided. In accordance with the method, a computing device obtains an identification of a set of data fields for collecting user information. The set of data fields can correspond to various types of input types and each identified data field is associated with at least one contextual group. The computing device the displays the identified set of data fields in a user interface, such as a Web page or other display interface. The computing device obtains user input corresponding to at least a portion of the set of data fields and identifies data fields in the subset of the data fields that are associated with an error. The errors can be associated with incomplete, incorrect or inconsistent data entries. The computing device then selects a subset of data fields from the identified set of data fields. The subset of data fields is selected based upon identifying at least one contextual group corresponding to data fields associated with an error. The computing device displays the subset of data fields in a user interface.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating an exemplary networked environment including a plurality of client computing devices and a data collection service suitable for collecting information from a user in accordance with an aspect of the present invention;

FIG. 2 is a block diagram illustrating exemplary components of a client device suitable for providing user data to a data collection service in accordance with an aspect of the present invention;

FIG. 3 is a block diagram illustrating exemplary components of an illustrative server in the data collection service suitable for collecting user data from client devices in accordance with an aspect of the present invention;

FIG. 4 is a flow diagram illustrative of a data collection routine implemented by the data collection service in accordance with an aspect of the present invention;

FIG. 5 is a flow diagram illustrative of an error processing sub-routine implemented by the data collection service in accordance with an aspect of the present invention;

FIG. 6 is a block diagram illustrative of a screen display corresponding to a set of data fields displayed on a client computing device for collecting data in accordance with an aspect of the present invention;

FIG. 7 is a block diagram illustrative of a screen display corresponding to a subset of data fields organized by contextual groups and displayed on a client computing device in accordance with an aspect of the present invention; and

FIG. 8 is a block diagram illustrative of a screen display corresponding to a subset of data fields organized by contextual groups and displayed on a client computing device in accordance with an aspect of the present invention.

### DETAILED DESCRIPTION

Generally described, the present invention relates to a system and method for collecting and processing user input from data fields. More specifically, the present invention relates to a system and method for processing user input from data fields utilizing contextual error messaging. The following detailed description describes exemplary embodiments of the invention. Although specific system configurations, screen displays, and flow diagrams are illustrated, it should be understood that the examples provided are not exhaustive and do not limit the present invention to the precise forms and embodiments disclosed. Persons skilled in the field of processing user data will recognize components and process steps described herein that may be interchangeable with other components or steps, or combinations of components or steps, and still achieve the benefits and advantages of the invention.

It should also be understood that the following description is presented largely in terms of logic operations that may be performed by conventional computer components. These computer components, which may be grouped at a single location or distributed over a wide area on a plurality of devices, generally include computer processors, memory storage devices, display devices, input devices, etc. In circumstances where the computer components are distributed, the computer components are accessible to each other via communication links.

In the following description, numerous specific details are set forth in order to provide a thorough understanding of the invention. However, it will be apparent to one skilled in the art that the invention may be practiced without some or all of these specific details. In other instances, well-known process steps have not been described in detail in order not to unnecessarily obscure the invention.

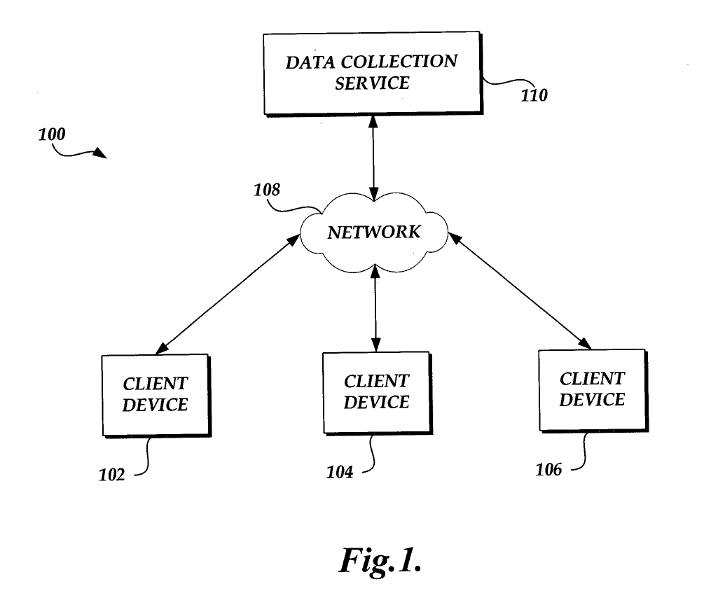

With regard to the operating environment for the present invention, FIG. 1 illustrates an exemplary networked environment 100 suitable for collecting user information in accordance with aspects of the present invention. The exemplary networked environment 100 of FIG. 1 includes one or more consumer devices, such as client devices 102-106, by which a user (not shown) can be presented with one or more user interface displays for collecting data. The client devices, such as client devices 102-106, are typically computing devices including a variety of configurations or forms such as, but not limited to, laptop or tablet computers, personal computers, personal digital assistants (PDAs), hybrid PDA/mobile phones, mobile phones, workstations, and the like. The client devices communicate via a communication network, such as the Internet 108, with a data collection service 110. In an illustrative embodiment, the data collection service 110 may comprise one or multiple servers or discrete components to a data collection process over the network.

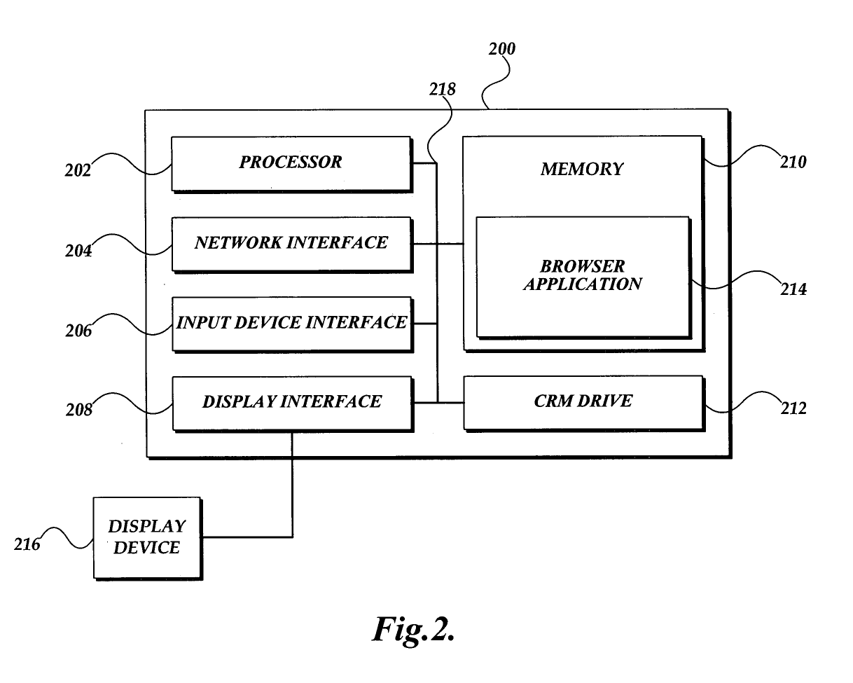

FIG. 2 is a block diagram illustrating exemplary components of a client device suitable for communicating via the Internet 108. Of course, while various components are described below, those skilled in the art of computers will recognize a wide selection of commercially available components that can be used to construct a consumer device suitable for submitting user input into data fields and/or processing the user input. Accordingly, the following description of the exemplary components of a client device should be viewed as illustrative only, and not construed as limiting in any manner.

With regard to FIG. 2, the illustrated client device 200 includes a processor 202 in communication with a variety of other components over a system bus 218. The exemplary components include, by way of example, a network interface 204, an input device interface 206, a display interface 208, a computer-readable medium drive 212, and a memory 210. As appreciated by those skilled in the art, the network interface 204 enables the client device 200 to communicate data, control signals, data requests, and other information with a computer network, such as the Internet 108 (FIG. 1). The network interface 204 may be configured to communicate with the Internet 108 over a wired or wireless connection.

The input device interface 206, sometimes also embodied as an input/output interface, enables the client device 200 to obtain data input from a user. Input devices in communication with the input device interface 206 may include, but are not limited to, a digital pen, a touch screen, a keyboard, a mouse, and the like. In addition, a display interface 208 is typically connected to a display device 216 (e.g., a CRT monitor, an LCD screen, a television, etc.) for visually displaying information to the consumer. Those skilled in the art will appreciate that the display device 216 may be incorporated within a client device as an integral element of the client device, or alternatively, may be an external component that is attached to the consumer device. FIG. 2 illustrates that the display device 216 is external to the client device 200, but this is illustrative only.

The processor 202 is configured to operate in accordance with programming instructions stored in a memory, such as the memory 210. The memory 210 generally comprises RAM, ROM, and/or permanent memory. Thus, in addition to storage in read/write memory (RAM), programming instructions may also be embodied in read-only format, such as those found in ROM or other permanent memory.

The memory 210 also typically stores an operating system (not shown) for controlling the general operation of the client device 200. The operating system may be a general purpose operating system such as a Microsoft® operating system, UNIX® operating system, or Linux® operating system, or an operating system specifically written for and tailored to the client device 200. The memory 210 may further store user-executable applications or programs for conducting various functions on the consumer device 200. For example, FIG. 2 illustrates that memory 210 includes a browser application 214 that may be used by a user to navigate on the Internet 108, and through which the consumer may communicate via the Internet 108 to transmit information to the data collection service 110. Examples of such browser applications include Microsoft's Internet Explorer®, Mozilla's Firefox, and the like.

The computer-readable medium drive 212 provides an optional and alternative means by which a consumer may store information externally and/or retrieve external information. Examples of computer-readable medium drives include, but are not limited to, CD ROM drives, DVD ROM drives, floppy disk drives, flash memory card readers, network drives, and the like. Of course, while computer-readable medium drive 212 is shown in the exemplary client device 200, it should be viewed as an optional component. Those skilled in the art will appreciate that not all client devices include a computer-readable medium drive 212. However, regardless of whether or not a client device includes a computer-readable medium drive 212, the client device may be entirely suitable for exchanging information with the data collection service 110 via the Internet 108.

Those skilled in the art will appreciate that various servers/components depicted in FIG. 1 are illustrative only. As mentioned above, an actual embodiment of the data collection service 110 may be comprised of a single computer or a plurality of discrete, cooperative servers distributed in a communications network. Similarly, the identified components should be viewed as logical components as each component may be physically embodied on one or more computer systems, as well as combined with other hardware and/or software components not illustrated herein. Further, although the exemplary networked environment 100 is illustrated as a client-server network configuration, the present invention may be implemented in a different network configuration, such as a peer-to-peer network configuration. Moreover, in an alternative embodiment, one or more aspects of the present invention may be implemented entirely within a client computing device 102-106 and would not require any type of network communication or the data collection service 110.

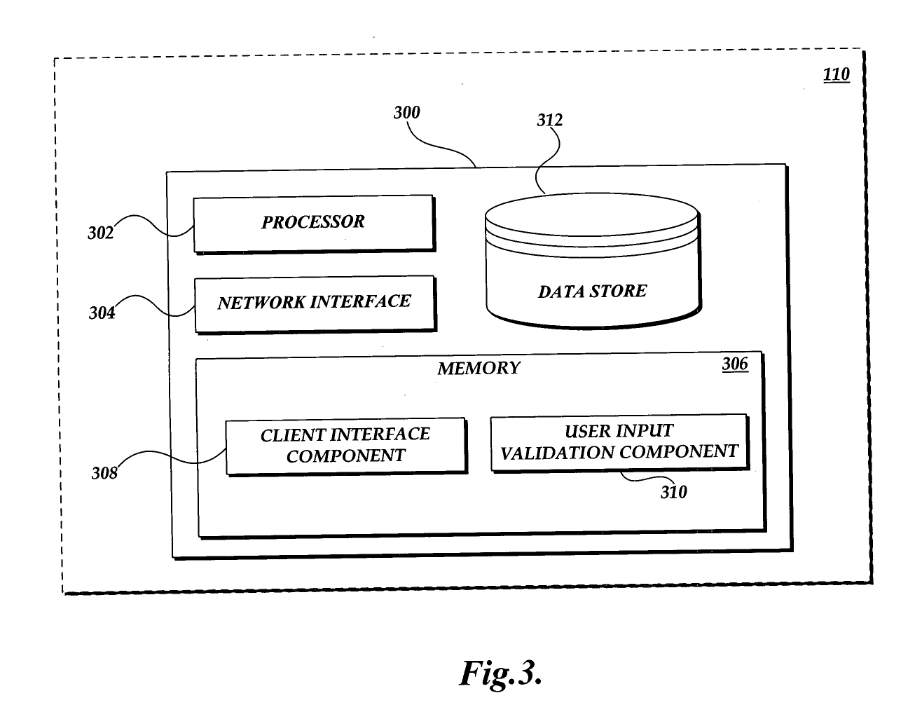

With regard to the data collection service 110, FIG. 3 is a block diagram illustrating exemplary components of a server computing device 300 that is suitable for collecting and processing user input from a client computing device. The server 300 includes a processor 302 in communication with a variety of other components over a system bus 316. The exemplary server components also include, but are not limited to, a network interface 304, a memory 306, a client interface component 308, a user input validation component 310, and a data store 312.

As with the consumer device 200, the processor 302 is configured to operate in accordance with programming instructions stored in a memory 306, which is generally comprised of RAM, ROM, and/or other permanent memory. The memory 306 will typically store an operating system for the server 300 upon which, and with which, most other programs/applications operate. Additionally, the memory 306 will also include one or more programs or applications that undertake the data collection process. Specifically, the client interface component 308 is operable to generate a set of user interface displays for the collection of user data from a client computing device. Additionally, the client interface component 308 is operable to generate one or more successive user interface displays for limiting the number of incorrectly filled data fields displayed to a user. The user input validation component 310 is operable to validate data associated with the one or more data fields displayed to the user by the client interface component 308. The operation of the client interface component 308 and/or the user input validation component 310 will be described in greater detail below. The data store 312 may be utilized to store data validation rules, previously submitted user data and/or currently submitted user data.

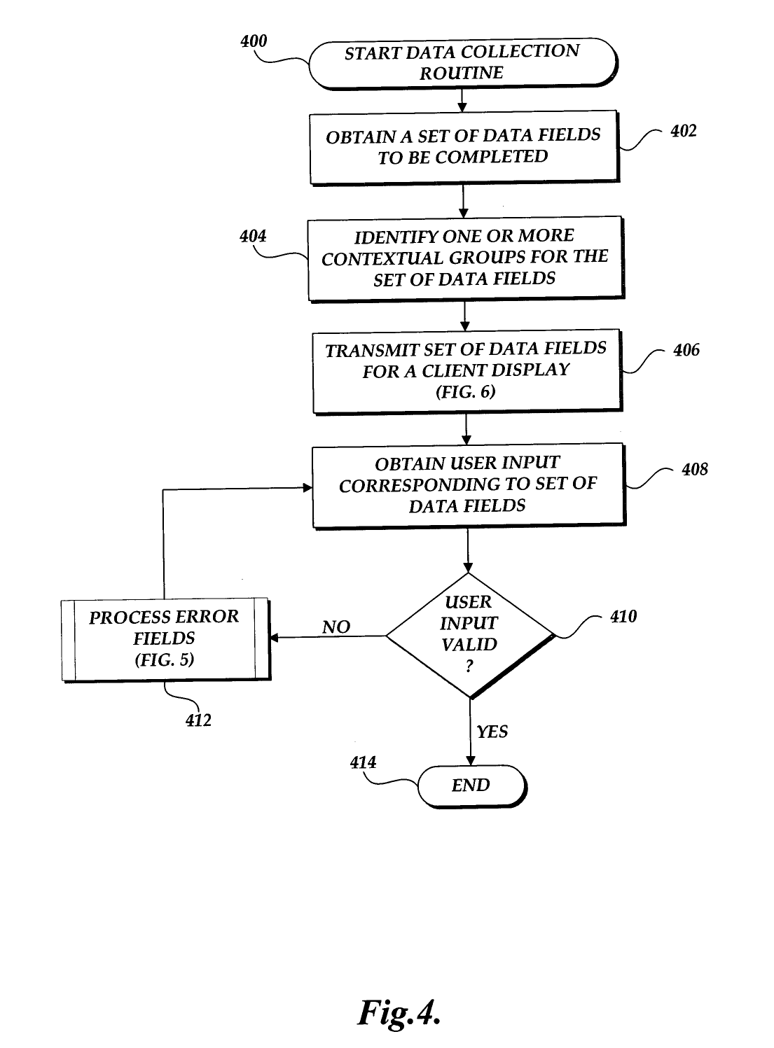

With reference now to FIG. 4, a data collection routine 400 for processing user input from a data fields will be described. In an illustrative embodiment of the present invention, the data collection routine 400 can be implemented by the data collection service 110 (FIG. 1). As previously discussed, however, the routine 400 may be implemented by the client computing devices 102-106 in either a peer-to-peer network configuration or as a stand alone data collection routine. Turning to FIG. 4, at block 402, the client interface component 308 obtains a set of data fields to be displayed to the user. In an illustrative embodiment, the set of data fields may be embodied as preconfigured set of fields to be displayed to users, such as preconfigured Web page. Alternatively, the set of data fields may be collected without any definition of how they are to be displayed to a user.

At block 402, the client interface component 308 organizes the set of data fields into contextual groups. In an illustrative embodiment, a contextual group can correspond to a grouping of data fields or processes that are indicative of a particular context or logical information architecture. For example, user contact information contextual group may include any number of data fields related to the collection of contact information such as name, mailing address, home address, apartment number, suite number, city, zip code, country, email addresse(s), telephone number(s), facsimile numbers, Web site URLs, on-line identifier, and the like. In an illustrative embodiment, a data field, such a user name field, may be associated with one or more contextual groups. Additionally, in an illustrative embodiment, the set of data fields may be associated with Meta data that identifies contextual groupings for each of the data fields. Alternatively, the contextual grouping information may be determined via manual inspection and/or various data processing algorithms.

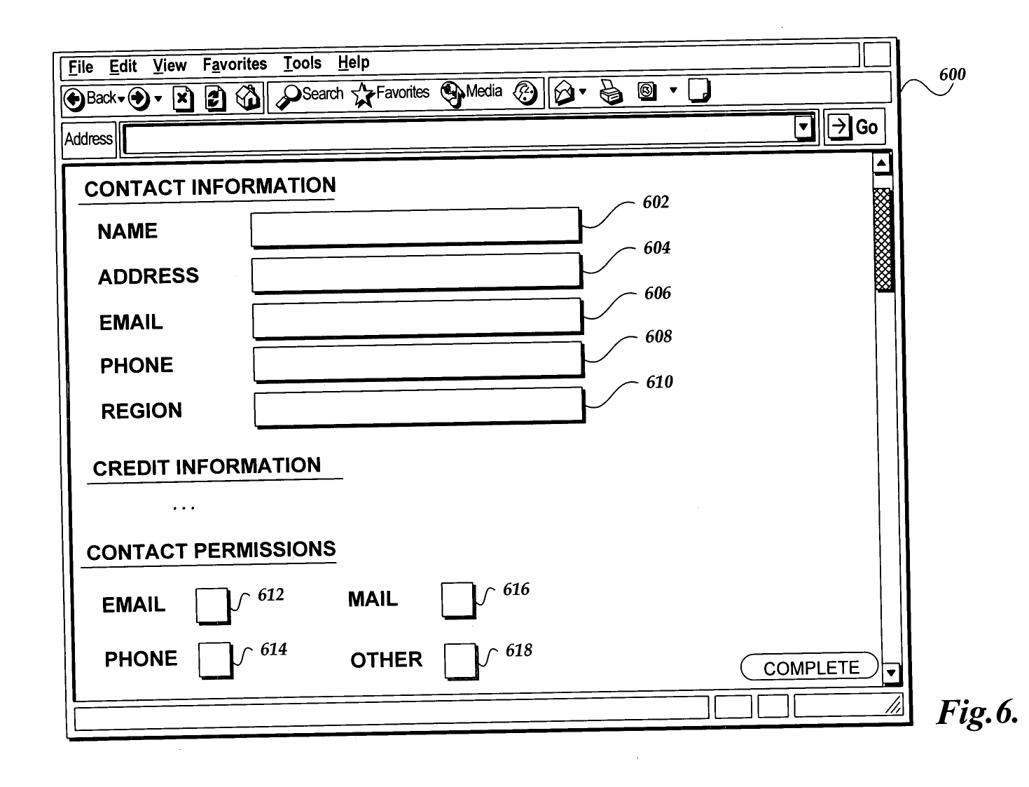

At block 406, the client interface component 308 transmits a set of data fields to a client computing device 102-106. In an illustrative embodiment, the set of data fields can be transmitted as a screen display, such as a Web page, user interface application, etc., for display on the client computing device. The display of the set of data fields can be organized into one or more of the contextual groups. FIG. 6 is a block diagram illustrative of a screen display 600 of a set of fields for receiving input from a user on a client computing device. As illustrated in FIG. 6, the screen display 600 includes a first subset of data fields 602-610 that correspond to a first contextual grouping and a second subset of data fields 612-620 that correspond to a second contextual grouping. By way of example, the first subset of data fields 602-610 could correspond to billing address and contact information while the second subset of data fields 612-620 could correspond to contact permissions. As illustrated in FIG. 6, the screen display 600 could include a large number of data fields that are displayed to the user in a single user interface. Although fields 602-610 are illustrated as being associated and grouped with a particular contextual grouping, one skilled in the relevant art will appreciate that additional or alternative grouping criteria may be utilized to display the set of display fields. Additionally, each of the data fields 602-620 may also be associated with other contextual groupings.

Returning to FIG. 4, at block 408, the client interface component 308 obtains user input corresponding to the set of data fields. In an illustrative embodiment, a client computing device may transmit the user input as it is inputted in each data field. Alternatively, the client computing device may transmit all or portions of the user input periodically, after a designated amount of time, upon receipt of a user indication of completion, and the like. Still further, in an alternative embodiment, one or more fields from the set of fields may be pre-populated by either the client computing device 102-106 and/or the data collection service 110. At decision block 410, a test is conducted to determine whether the user input is valid. In an illustrative embodiment, the user input validation component 310 can process the user input to determine whether the user input is of a valid form. In another embodiment, the user input validation component 310 can compare data in one or more fields with data previously entered in the same or a similar field to identify an inconsistent data. Still further, in another embodiment, the user input validation component 310 can also utilize a rules based system, support vector machines and/or neural networks to identify potential incorrect or inconsistent data. If the user input validation component 310 determines that is an error or inconsistency with a field, at block 412, the client interface component 308 processes the input error and the routine 400 returns to block 408. An illustrative sub-routine for processing the input error will be described below in greater detail. Alternatively, once there are no additional errors or inconsistencies in the set of data fields, the routine 400 terminates at block 414.

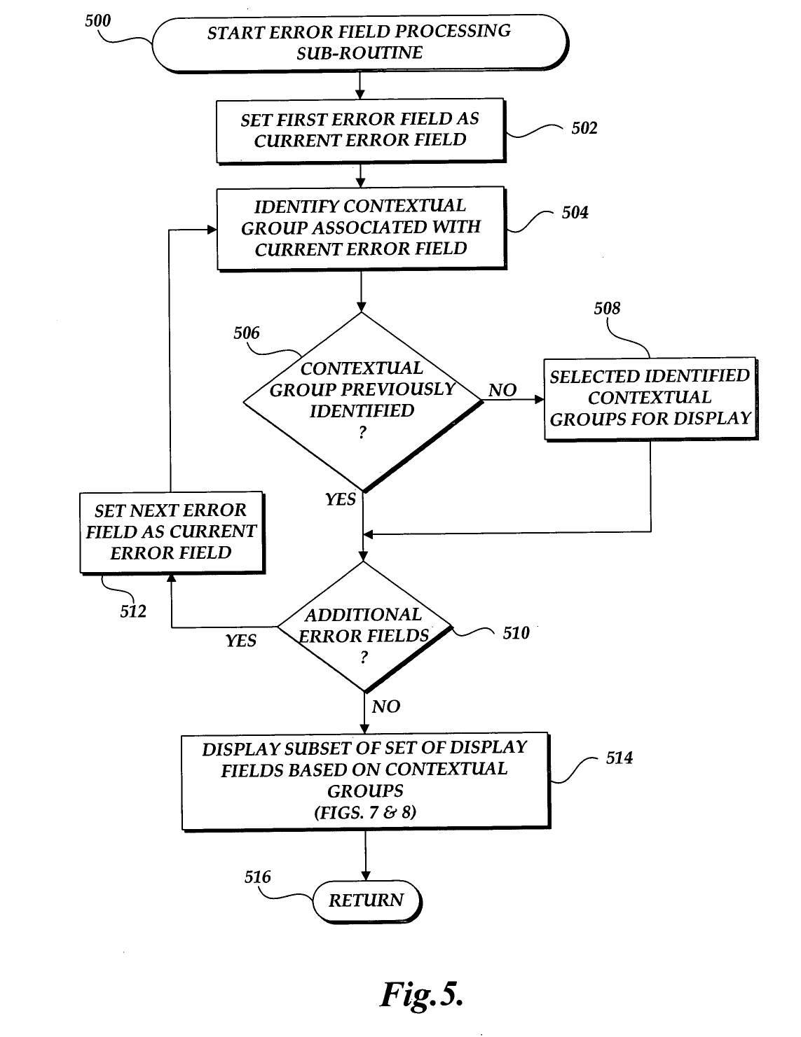

Turning now to FIG. 5, a sub-routine 500 for processing input error or input inconsistencies will be described. At block 502, the client interface component 308 sets the first error field as a current error field. At block 504, the client interface component 308 identifies the one or more contextual groups associated with the current error field. At decision block 310, a test is conducted to determine whether the one or more contextual groups associated with the current error field has been previously identified as pertaining to an error field. If not, at block 508, the one or more contextual groups are selected for display to the user.

Once the one or more contextual groups have been selected for display or if the contextual groups have been previously selected for display, at decision block 510, a test is conducted to determine whether additional error fields remain. If so, at block 512, the client interface application 308 sets the next error field as the current error field and the sub-routine 500 returns to block 504. Alternatively, if no additional error fields remain, at block 514, the client interface application presents one or more user interface displays that correspond to the contextual group of the identified error field. In the event that multiple contextual groups may be selected, the client interface application 308 may select a single contextual grouping that may be applicable to multiple error fields, that may have a higher relevance as determined by user feedback and the like. Alternatively, the client interface application 308 may also present the user with multiple contextual groupings to allow the user to select which contextual groupings they prefer. In an illustrative embodiment, the client interface application 308 may generate a series of user interface displays that include a single contextual grouping in each user interface display. Alternatively, the client interface application 308 may combine two or more contextual groupings into a single user interface. At block 516, the sub-routine 500 returns.

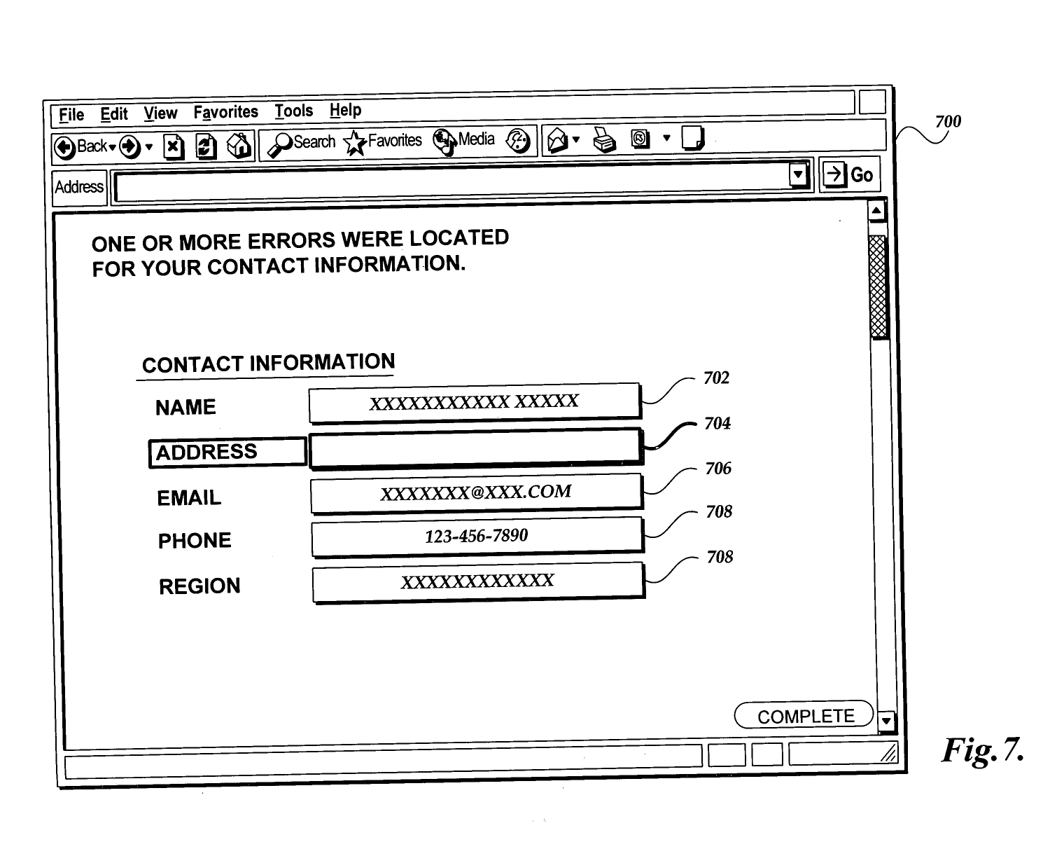

FIG. 7 is a block diagram illustrative of a screen display 700 of a display of contextual groupings for processing an error field in accordance with the present invention. With reference to screen display 600 (FIG. 6), by way of illustration, the screen display 700 corresponds to a contextual grouping for an error field associated with field 604 (“Address”). The screen display 700 includes at least a subset of the data fields in previous screen display 600 that are associated with the contextual grouping for field 604. Accordingly, data fields 702-710 replicate some of the correctly entered data field and the error field, all of which are associated with contact information contextual grouping. The error field, field 704, may also be further identified to the user.

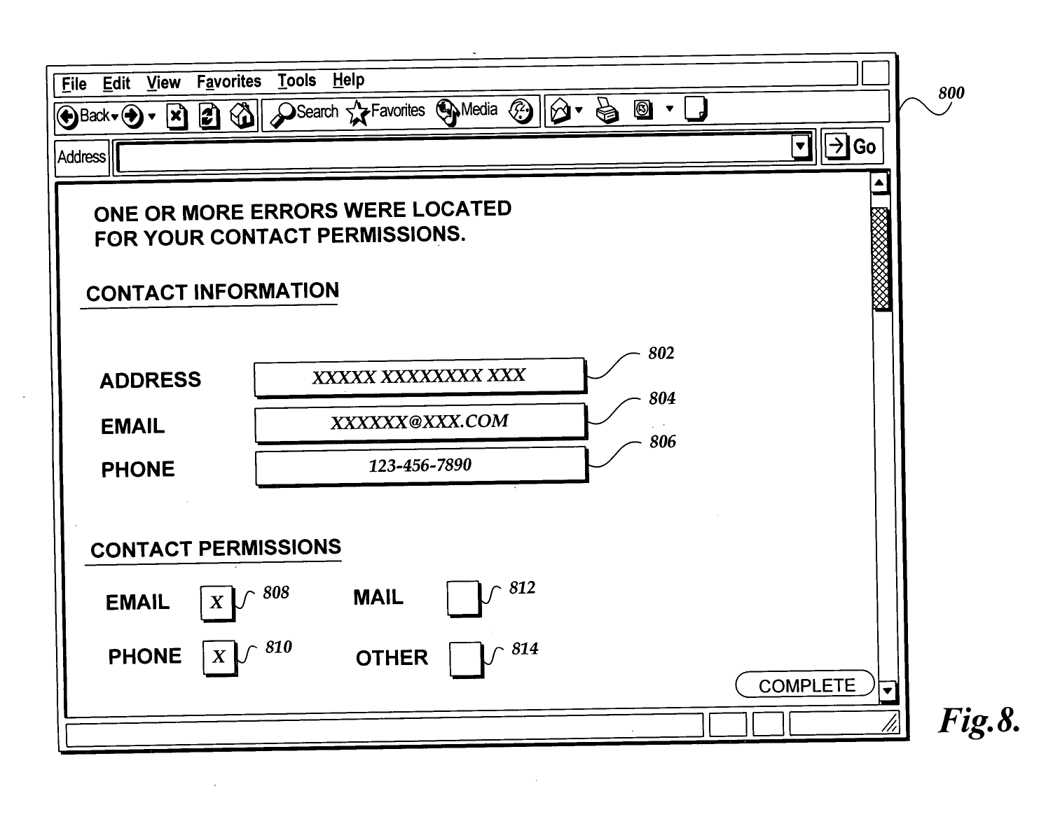

FIG. 8 is a block diagram illustrative of a screen display 800 of a display of contextual groupings for processing an error field in accordance with the present invention. With reference to screen display 600 (FIG. 6), by way of illustration, the screen display 800 corresponds to a contextual grouping for an error field associated with one of the contact permission data fields 612-618. The screen display 800 includes at least a subset of the data fields in previous screen display 600 that are associated with the contextual grouping for fields 612-618. Accordingly, data fields 802-814 replicate some of the correctly entered data field and the error field, all of which are associated with contact information contextual grouping. In this illustrative example, data fields 802-806 correspond to data fields from the “Contact Information” grouping, but that can be associated in the same contextual group as the error fields 808-814.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for processing information from data fields comprising:
obtaining an identification of a set of data fields for collecting user information, wherein each identified data field is associated with at least one contextual group;
displaying the identified set of data fields in a user interface;
obtaining user input corresponding to at least a portion of the set of data fields;
determining that at least one data field in the subset of the data fields is associated with an error;
selecting a subset of data fields from the identified set of data fields, wherein the subset of data fields correspond to a contextual group for the at least one data field associated with an error; and
displaying the subset of data fields in a user interface.
